(19) United States
(12) Patent Application Publication
(10) Pub. No.: US 2003/0184487 A1
(43) Pub. Date: Oct. 2, 2003

(54) Reflector/feed antenna with reflector mounted waveguide diplexer-OMT

(76) Inventors: Glenn J. Desargant, Fullerton, CA (US); Albert Louis Blen, Anaheim, CA (US)

Correspondence Address: HARNESS, DICKEY & PIERCE, P.L.C., P.O. BOX 828, BLOOMFIELD HILLS, MI, 48303, US

(21) Appl. No.: 10/107,513

(22) Filed: Mar. 27, 2002

(51) Int. Cl. H01Q 13/00

(52) U.S. Cl. 343/781 P; 343/779

(57) ABSTRACT

A dual polarized, transmit/receive Cassegrain antenna system having an improved gain/temperature (G/T) ratio and improved effective isotropic radiated power (EIRP). The antenna has a main reflector, a subreflector, a waveguide feedhorn and a waveguide diplexer—ortho-mode transducer (OMT) attached to the waveguide feedhorn at the vertex in the back of the main reflector. Vertical and horizontal components of the transmit and receive signals are separated into four independent channels. The four channels are coupled from the waveguide diplexer-OMT in four directions to allow placement of the vertical and horizontal solid state power amplifiers (SSPA) and the vertical and horizontal low noise amplifiers (LNA) directly on the back of the antenna. Location of the SSPAs and LNAs in this manner provides minimum transmission loss and volume.

### FIELD OF THE INVENTION

The present invention relates to antennas. More specifically, the invention relates to a method and apparatus for providing a minimum feed loss, minimum volume, dual polarized, transmit/receive Cassegrain antenna system.

### BACKGROUND OF THE INVENTION

Radio frequency (RF) antennas are widely used to transmit and receive energy in the form of radio waves. RF antennas are available in many different shapes, sizes and configurations. One type of RF antenna is the Cassegrain antenna. Cassegrain antennas make use of a sub-reflector having a hyperbolic shape which is aimed at the axial center of a main parabolic reflector. When the antenna is in the receive mode the sub-reflector directs RF energy received and reflected by the main reflector to a waveguide (i.e., feedhorn) located at the axial center of the main reflector. When the antenna is in the transmit mode, RF energy transmitted from the waveguide is reflected by the sub-reflector onto the main reflector where the energy is radiated from the antenna.

Cassegrain antennas also make use of a waveguide diplexer ortho-mode transducer (OMT). The waveguide diplexer-OMT is directly connected to the waveguide feedhorn. The waveguide diplexer-OMT preferably has four channels that are used to amplify the transmit and receive vertical and horizontal energies. Vertically polarized energy transmitted is amplified by a vertical solid state power amplifier (SSPA) while horizontally polarized energy transmitted is amplified by a horizontal SSPA. Likewise, the vertically polarized energy received is amplified by a vertical low noise amplifier (LNA) and the horizontally polarized energy received is amplified by a horizontal LNA. In current antennas that employ both LNA's and SSPA's, the LNA's and SSPA's are located at a distance to the waveguide diplexer-OMT and connected to the waveguide diplexer-OMT by way of a waveguide or by a transmission line such as a coaxial cable.

While the above described Cassegrain antenna is able to adequately send and receive radio signals, it would be desirable to improve its operating efficiency. Specifically, the above described Cassegrain antenna experiences transmission losses due to the use of a device, such as a waveguide or coaxial cable, which is needed to connect the remote LNAs, and SSPAs to the waveguide diplexer-OMT. Due to transmission losses, the above described antenna exhibits a low gain/temperature (G/T) ratio and low effective isotropic radiated power (EIRP) levels. Consequently, there is a need for a Cassegrain antenna that is able to achieve a higher G/T ratio and improved EIRP levels through the reduction of transmission losses.

### SUMMARY OF THE INVENTION

The present invention overcomes the prior art deficiencies by providing a Cassegrain antenna having an improved gain/temperature ratio (G/T) as well as higher effective isotropic radiated power (EIRP) levels. Such enhanced properties are obtained by connecting the four amplifier channels directly to the waveguide diplexer-ortho-mode transducer (OMT). The four amplifier channels comprise a vertical solid state power amplifier (V-SSPA) for amplifying vertically polarized transmitted RF energy, a horizontal solid state power amplifier (H-SSPA) for amplifying horizontally polarized transmitted RF energy, a vertical low noise amplifier (V-LNA) for amplifying vertically polarized received energy, and a horizontal low noise amplifier (H-LNA) for amplifying horizontally polarized received energy. Connecting the four channels directly to the waveguide diplexer-OMT eliminates the need for connecting devices, such as waveguide and coax transmission lines, elevation and azimuth rotary joints, and waveguide to coax connections, thus eliminating the transmission loss that is associated with using such connecting devices. By eliminating the need for a connection device between the amplifier channels and the diplexer-OMT the current invention is able to provide a Cassegain antenna having an improved gain/temperature ratio (G/T) as well as higher effective isotropic radiated power (EIRP) levels.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic illustration of a side view of a Cassegrain antenna in accordance with a preferred embodiment of the present invention.

FIG. 2, is a schematic illustration of a rear view of the main reflector of the Cassegrain antenna of FIG. 1.

### DETAILED DESCRIPTION OF THE PREFERRED EMBODIMENTS

The following description of the preferred embodiments is merely exemplary in nature and is in no way intended to limit the invention, its application, or uses.

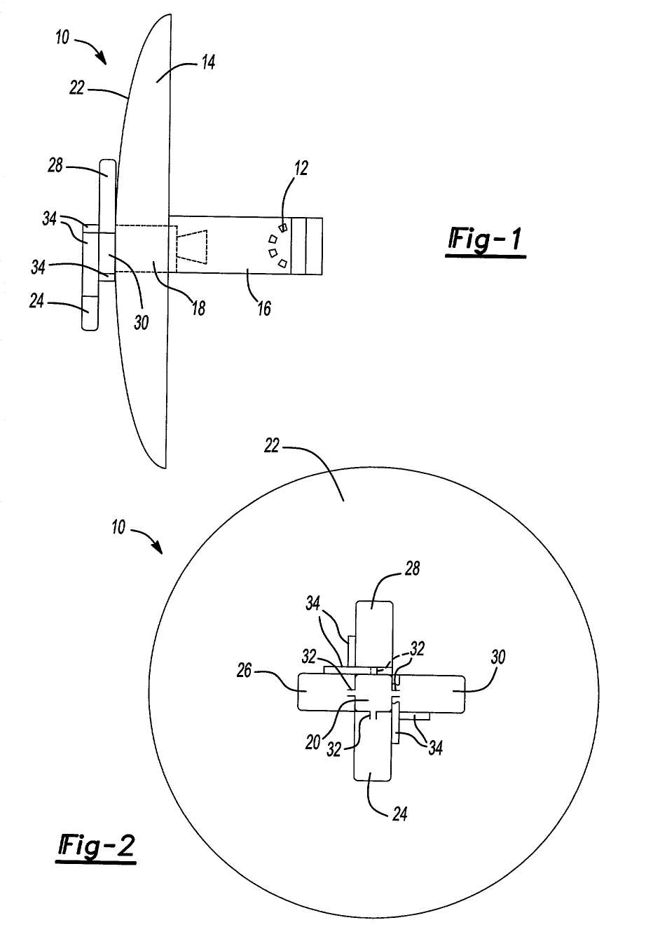

As seen in FIGS. 1 and 2, a Cassegrain antenna 10 in accordance with a preferred embodiment of the present invention is shown. The antenna 10 comprises a sub-reflector 12 and a main reflector 14. The subreflector 12 is mounted to the main-reflector 14 by a support tube 16. RF signals received by the main reflector 14 are reflected by the sub-reflector 12 to a waveguide in the form of feedhorn 18. RF signals transmitted through the feedhorn 18 are reflected by the sub-reflector 12 to the main reflector 14 and radiated by the main reflector 14 into space.

Directly connected to an input (not shown) of the feedhorn 18 is a waveguide diplexer—ortho-mode transducer (OMT) 20. The waveguide diplexer-OMT 20 is mounted to a rear surface 22 of the main reflector 14 by any suitable mounting device, such as one or more suitably shaped brackets (not shown). The waveguide diplexer-OMT 20 splits a received RF signal into its horizontal and vertical components and combines the horizontal and vertical components of a transmitted signal.

In order to amplify the RF signals received and transmitted by the antenna 10, four amplifier channels are secured to the surface of the waveguide diplexer-OMT 20 using a suitable device or process such as soldering or dip-brazing. The four channels are orientated at 90-degree intervals to each other and include a vertical solid-state power amplifier (V-SSPA) 24, a horizontal solid-state power amplifier (H-SSPA) 26, a vertical low noise amplifier (V-LNA) 28, and a horizontal low noise amplifier (H-LNA) 30.

Specifically, vertically polarized transmitted RF energy is amplified by the V-SSPA 24, while horizontally polarized transmitted RF energy is amplified by the H-SSPA 26. Likewise, the vertically polarized RF energy received is amplified by the vertical low noise amplifier V-LNA 28 and horizontally polarized energy received is amplified by the H-LNA 30. RF energy passes between the waveguide diplexer-OMT 20 and the amplifier channels 24, 26, 28, and 30 through waveguide ports 32 disposed within the surface of the waveguide diplexer-OMT 20 at the point of contact between the waveguide diplexer-OMT 20 and the amplifier channels 24, 26, 28, and 30. The LNA channels 28, 30 and the SSPA channels 24, 26 may be combined in a polarization network to transmit and receive all linear polarizations and right- or left-hand circular polarization.

Antenna 10 also comprises support plates 34. Each of the support plates 34 extend from a different side of the waveguide diplexer-OMT 20. The end of each support plate 34 opposite the waveguide diplexer-OMT 20 is secured to one of the amplifier channels 24, 26, 28, and 30. The support plates 34 are secured to the waveguide diplexer-OMT 20 and amplifier channels 24, 26, 28, and 30 using any suitable fastening device or method such as dip brazing. The support plates 34 are inserted to provide additional support to the connection between the waveguide diplexer-OMT 20 and the amplifier channels 24, 26, 28, and 30.

Because the amplifier channels 24, 26, 28, and 30 are directly mounted to the waveguide diplexer-OMT 20, RF energy may travel between the waveguide diplexer-OMT 20 and the amplifier channels 24, 26, 28, and 30 without the need of a transmission line or waveguide. Consequently, transmission losses associated with the transmission of a signal through a transmission line, waveguide, or rotary joint are avoided, thus advantageously providing a Cassegrain antenna with a higher gain/temperature (G/T) ratio and higher effective isotropic radiated power (El RP) levels.

Thus, an improved Cassegrain antenna 10 exhibiting reduced transmission line loss, increased gain/temperature ratio, and increased isotropic radiated power levels is provided. The decrease in transmission line loss is due to the elimination of the transmission line or waveguide connection between the waveguide diplexer-OMT 20 and the SSPA 24, 26 and LNA 28, 30 amplifier channels. In prior art Cassegrain antennas, such a transmission line causes transmission losses resulting in a lower gain/temperature ratio and lower effective isotropic radiated power (EIRP) levels. Further, the amplified receive and transmit channels 24, 26, 28, and 30 and RF signals provide a transmit/receive communication system for mobile aircraft, the system having polarization diversity capability for communicating with satellites having different polarizations.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An antenna having an improved gain/temperature ratio and an improved effective isotropic radiated power, comprising:
a main reflector;
a subreflector disposed adjacent said main reflector so as to face said main reflector and further being aligned with an axial center of said main reflector;
a waveguide disposed at said axial center of said main reflector;
a transducer disposed closely adjacent the waveguide of said main reflector for transmitting radio frequency (RF) energy into said waveguide; and
at least one amplifier channel disposed closely adjacent to said transducer.

2. The antenna of claim 1, wherein said transducer comprises a waveguide diplexer—ortho-mode transducer.

3. The antenna of claim 2, wherein said waveguide diplexer—orthomode transducer is mounted directly to a rear surface of said main reflector.

4. The antenna of claim 1, wherein said at least one amplifier channel comprises a vertical receive low noise amplifier channel, a horizontal receive low noise amplifier channel, a vertical transmit solid state amplifier channel, and a horizontal transmit solid state amplifier channel.

5. The antenna of claim 1, wherein said at least one amplifier channel is secured directly to said waveguide diplexer—ortho-mode transducer.

6. A method for forming a reflector antenna having an improved gain/temperature ratio and improved effective isotropic radiated power, comprising:
providing a main reflector;
disposing a subreflector in front of said main reflector and coaxially aligned with an axial center of said main reflector;
disposing a waveguide at said axial center of said main reflector;
disposing a transducer for generating RF energy closely adjacent a rear surface of said main reflector such that an output of said transducer can be directly coupled to an input of said waveguide;
disposing at least one amplifier channel closely adjacent a surface of said transducer so that RF energy may pass directly between the at least one amplifier channel and said transducer; and
wherein said direct passage of RF energy from said amplifier to said transducer reduces transmission line loss and volume loss in feeding said RF energy to said waveguide.

7. The method of claim 6, wherein said transducer comprises a waveguide diplexer-ortho mode transducer.

8. The method of claim 7, wherein said waveguide diplexer-ortho mode transducer is mounted directly to a rear surface of said main reflector.

9. The method of claim 6, wherein said at least one amplifier channel comprises a vertical receive low noise amplifier channel, a horizontal receive low noise amplifier channel, a vertical transmit solid state amplifier channel, and a horizontal transmit solid state amplifier channel.

10. The method of claim 6, wherein said at least one amplifier channel is secured directly to said waveguide diplexer—ortho-mode transducer.
